(19) United States
(12) Patent Application Publication
(10) Pub. No.: US 2005/0107990 A1
(43) Pub. Date: May 19, 2005

(54) Distributed testing system having framework for adding measurements and physical agents

(76) Inventors: John M. Monk, Monument, CO (US); Robert H. Kroboth, Peyton, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/715,596

(22) Filed: Nov. 19, 2003

(51) Int. Cl. G06F 11/00

(52) U.S. Cl. 702/188

(57) ABSTRACT

A distributed testing system including (a) a logical agent; (b) a server communicating with the logical agent; (c) a graphical user interface (GUI) communicating with the server; and (d) a framework. The framework interfaces physical agents to the logical agent, the server and the GUI via plug-ins. The framework also interfaces a plurality of measurements to the server and the GUI via plug-ins. The interfaced physical agents perform the interfaced heterogeneous measurement for a test of a communications network in accordance with control by an end user via the GUI.

### BACKGROUND OF THE INVENTION

1. Field of the Invention

The present invention relates to a distributed testing system and, more particularly, to a distributed testing system having a framework for adding measurements and physical agents.

2. Description of the Related Art

A measurement is something being measured on a communications network. For example, a measurement may determine the characteristics or amount of Internet Protocol (IP) traffic or voice-over-Internet-Protocol (VOIP) traffic on a packet network. Generally, a measurement represents a plurality of related, measured variables. For example, a measurement of VOIP traffic might be based, for example, on related variables such as packet jitter, packet delay and packet loss. The concept of a measurement is well-known.

Network Analyzers (NAs) are used to perform measurements. NAs are often specialized for performing particular measurements. Moreover, a single NA can often perform multiple measurements. NAs are well-known.

However, generally, NAs are limited to performing measurements. An NA cannot perform a test of the network, where a test is a collection of measurements running on one or more NAs correlated together and presented in a single unified location (i.e., a window of a GUI).

### SUMMARY OF THE INVENTION

Accordingly, the present invention provides a comprehensive, distributed testing system for testing a network.

Moreover, the present invention provides a distributed testing system which is easily extensible to add new measurements and physical agents (such as, for example, NAs) via the use of software plug-ins. By adding new measurements and physical agents, new tests can thereby be added.

The present invention provides a distributed testing system comprising a logical agent, a server communicating with the logical agent and a graphical user interface (GUI) communicating with the server. The distributed testing system is extensible to, without technical intervention, interface with physical agents and heterogeneous measurements so that the interfaced physical agents perform the interfaced heterogeneous measurements for a test in accordance with control by an end user via the GUI.

The present invention also provides an apparatus including (a) a logical agent; (b) a server communicating with the logical agent; (c) a graphical user interface (GUI) communicating with the server; and (d) a framework. The framework interfaces, without technical intervention, physical agents to the logical agent, the server and the GUI via plug-ins. The framework also interfaces, without technical intervention, a plurality of measurements to the server and the GUI via plug-ins. The interfaced physical agents perform the interfaced heterogeneous measurement for a test in accordance with control by an end user via the GUI.

Moreover, the present invention provides an apparatus including (a) a logical agent; (b) a server communicating with the logical agent; (c) a graphical user interface (GUI) communicating with the server; (d) a GUI integration framework interfacing the GUI with GUI plug-ins for physical agents, and interfacing the GUI with GUI plug-ins for heterogeneous measurements; (e) a server integration framework interfacing the server with server plug-ins for the physical agents, and interfacing the server with server plug-ins for the heterogeneous measurements; and (f) an agent integration framework interfacing the logical agent with agent plug-ins for the physical agents, the physical agents thereby performing the heterogeneous measurements for a test in accordance with control by an end user via the GUI.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a diagram illustrating a distributed testing system, according to an embodiment of the present invention.

FIG. 2 is a diagram illustrating a distributed testing system, according to an embodiment of the present invention.

FIG. 3 is a diagram illustrating the addition of a third party agent and a third party measurement to a distributed testing system, according to an embodiment of the present invention.

FIG. 4 is a diagram illustrating an object-oriented class hierarchy for a graphical user interface (GUI) integration framework of a distributed testing system, according to an embodiment of the present invention.

FIG. 5 is a diagram illustrating an object-oriented class hierarchy for a server integration framework of a distributed testing system, according to an embodiment of the present invention.

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

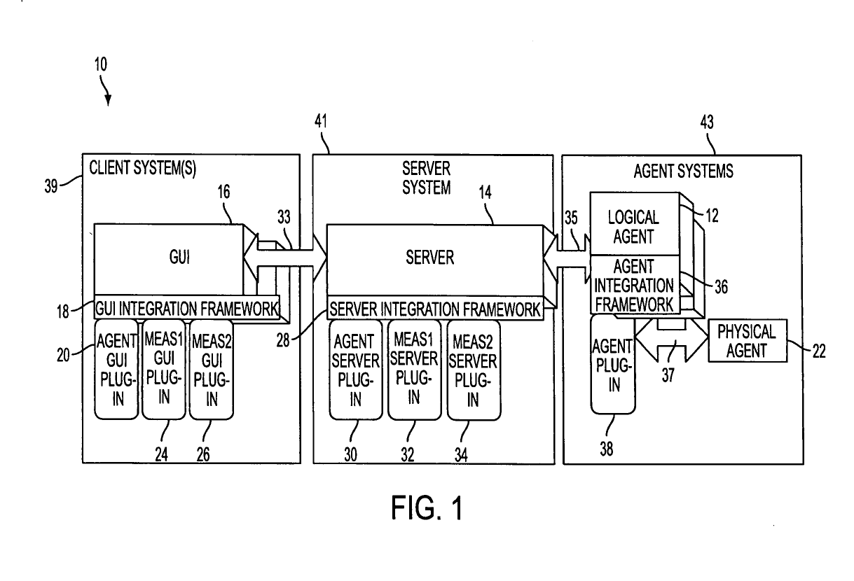

FIG. 1 is a diagram illustrating a distributed testing system, according to an embodiment of the present invention. Referring now to FIG. 1, a distributed testing system 10 includes a logical agent 12, a server 14 communicating with logical agent 12, and a graphical user interface (GUI) 16 communicating with server 14.

As will be described in more detail further below, distributed testing system 10 is extensible to, without technical intervention, interface with physical agents and heterogeneous measurements so that the interfaced physical agents perform the interfaced heterogeneous measurements for a test in accordance with control by an end user via GUI 16. Here, “without technical intervention” indicates that distributed testing system 10 can be extended to interface with the physical agents and the heterogeneous measurements without changing the software code, or writing new code, for distributed testing system 10. Instead, as will be described in more detail further below, distributed testing system 10 can be extended via the use of plug-ins having predefined application programming interfaces (APIs) for interfacing with distributed testing system 10.

For example, referring again to FIG. 1, a GUI integration framework 18 interfaces GUI 16 with a GUI plug-in 20 for a physical agent 22, and interfaces GUI 16 with a GUI plug-in (Meas 1 GUI Plug-in) 24 for a first measurement, and a GUI plug-in (Meas 2 GUI Plug-in) 26 for a second measurement. The first and second measurements are heterogeneous measurements.

Generally, the use of GUI integration framework 18 allows subsequently added measurements and physical agents to appear to the end user through GUI 16 as if the added measurements and physical agents were originally included as part of distributed testing system 10. The added measurements and physical agents can then be configured and controlled, and their results can then be displayed in a correlated manner, by an end user via GUI 16, as if the added measurements and physical agents were originally built into GUI 16.

A server integration framework 28 interfaces server 14 with a server plug-in 30 for physical agent 22, and interfaces server 14 with a server plug-in (Meas 1 Server Plug-In) 32 for the first measurement and a server plug-in (Meas 2 Server Plug-in) 34 for the second measurement.

An agent integration framework 36 interfaces logical agent 12 with an agent plug-in 38 for physical agent 22. Physical agent 22 is a hardware device which performs measurements. Logical agent 12 is a software representation of a physical agent, and allows communication through the software to the actual physical agent 22. The concept of a logical agent and a physical agent would be well-understood by a person of ordinary skill in the art.

Therefore, agent integration framework 36 allows plug-ins for new physical agents to be developed so that the new physical agents can be added to distributed testing system 10. Once added, the new physical agents can then be controlled by an end user via GUI 16 and by server 14 to perform measurements.

A “plug-in” (such as GUI plug-in 20, GUI plug-in 24, GUI plug-in 26, server plug-in 30, server plug-in 32, server plug-in 34 and agent plug-in 38) is a software module installable in the associated GUI integration framework 18, server integration framework 28 or agent integration framework 36 without requiring modification of the software code of GUI integration framework 18, server integration framework 28, agent integration framework 36, GUI 16, server 14 or logical agent 12. Therefore, a plug-in allows the measurement and testing capabilities of distributed testing system 10 to be extended at run-time. The concept of a “plug-in” would be well-understood by a person of ordinary skill in the art.

Accordingly, GUI integration framework 18, server integration framework 28 and agent integration framework 36 allow plug-ins to be developed based on a common application programming interface (API) provided in the frameworks.

With distributed testing system 10, physical agent 22 can perform the first and second measurements for a test in accordance with control by an end user via GUI 16. More specifically, with distributed testing system 10, GUI 16 communicates with server 14, and server 14 communicates with physical agent 22 through logical agent 12. In this manner, physical agent 22 performs measurements in accordance with control of an end user via GUI 16.

Various communication protocols can be used. For example, a communication channel 33 between GUI 16 and server 14 would use a communication protocol which might be, for example, Java Remote Method Invocation (RMI). A communication channel 35 between server 14 and logical agent 12 would use a communication protocol which might be, for example, XML over HTTP. A communication channel 37 between agent plug-in 38 and physical agent 22 would use a communication protocol which might, be, for example, an interprocess communication (IPC) protocol. However, the present invention is not limited to any particular communication protocol.

Server 14 might be a Network Troubleshooting Center (NTC) operating as a server. An NTC is a known device and might be, for example, an Agilent™ NTC such as, for example, an Agilent™ Model No. J6801A. Therefore, in this example, GUI 16 would be a GUI for the NTC. Physical agent 22 might be, for example, a Network Analyzer (NA). An NA is a known device and might be, for example, an Agilent™ NA, such as an Agilent™ Model No. J6801A. However, the present invention is not limited to server being an NTC, to GUI being a GUI for an NTC, or to an agent being an NA. Instead, there are many different types of computers and apparatus that can operate as a server or physical agent in distributed testing system 10. Moreover, there are many different types of GUIs that can be used in distributed testing system 10.

In FIG. 1, GUI 16, GUI integration framework 18 and GUI plug-ins 20, 24 and 26 are together shown as client system(s) 39. Server 14, server integration framework 28 and server plug-ins 30, 32 and 34 are together shown as server system 41. Logical agent 12, agent integration framework 36, agent plug-in 38 and physical agent 22 are together shown as agent systems 42.

Although FIG. 1 discloses only one physical agent 22 and two measurements, the present invention is not limited to any particular number of physical agents or measurements.

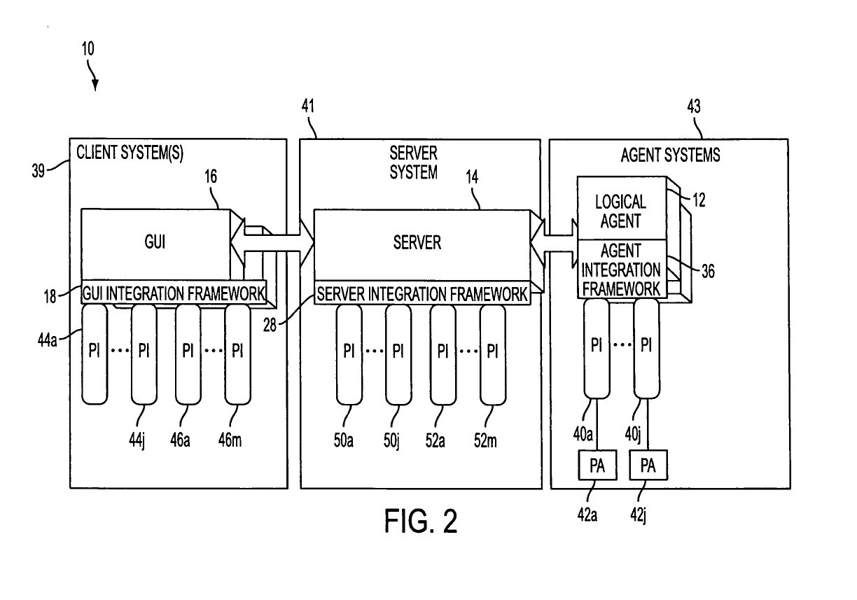

For example, FIG. 2 is a diagram illustrating a distributed testing system 10 interfacing with a plurality of physical agents for performing a plurality of measurements, according to an embodiment of the present invention. Referring now to FIG. 2, agent integration framework 36 interfaces logical agent 12 with agent plug-ins 40a through 40j for physical agents (PAs) 42a through 42j, respectively. GUI integration framework 18 interfaces GUI 16 with GUI plug-ins 44a through 44j for physical agents 42a through 42j, respectively, and interfaces GUI 16 with GUI plug-ins 46a through 46m for “m” heterogeneous measurements, respectively. Server integration framework 28 interfaces server 14 with server plug-ins 50a through 50j for physical agents 42a through 42j, respectively, and interfaces server 14 with server plug-ins 52a through 52m for the “m” heterogeneous measurements, respectively.

Therefore, in FIG. 2, physical agents 42a through 42j perform the heterogeneous measurements for a test in accordance with control by an end user via GUI 16.

As would be understood from the above, a respective measurement needs a physical agent 42a through 42j to perform the measurement. However, multiple measurements can be run on the same physical agent 42a through 42j. An end user can configure and control the measurements and physical agents 42a through 42j through a single GUI 16.

As can be seen from FIG. 2, to add a new physical agent, a plug-in for the physical agent must simply be added to GUI integration framework 18, server integration framework 28 and agent integration framework 36.

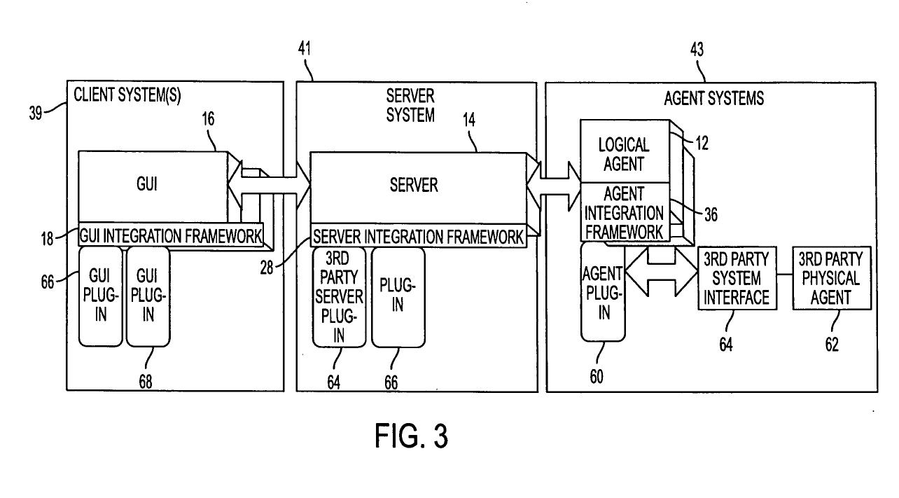

FIG. 3 is a diagram illustrating the addition of a third party agent and a third party measurement to a distributed testing system, according to an embodiment of the present invention. Referring now to FIG. 3, agent integration framework 36 interfaces logical agent 12 with an agent plug-in 60 for a third party physical agent 62 via a third party system interface 64. Server integration framework 28 interfaces server 14 with a server plug-in 64 for physical agent 62, and interfaces server 14 with a server plug-in 66 for the third party measurement. GUI integration framework 18 interfaces GUI 16 with a GUI plug-in 66 for physical agent 62, and interfaces GUI 16 with a GUI plug-in 68 for the third party measurement.

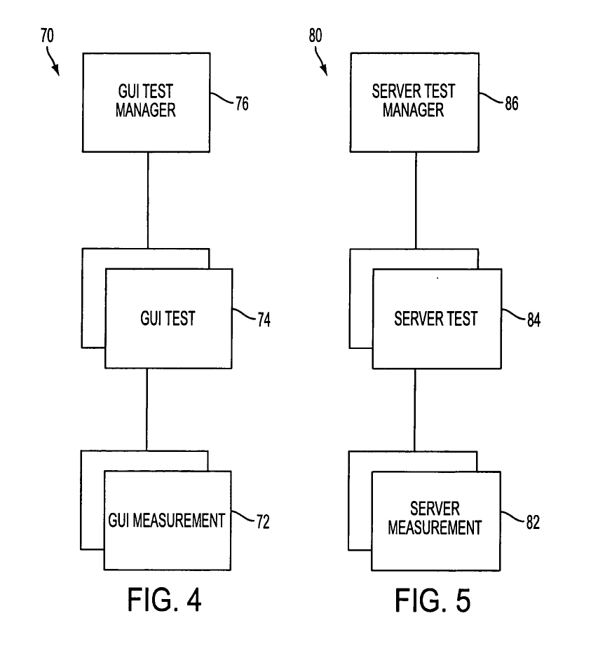

FIG. 4 is a diagram illustrating an object-oriented class hierarchy 70 for GUI integration framework 18 of distributed testing system 10, according to an embodiment of the present invention. More specifically, class hierarchy 70 interfaces GUI 16 with GUI plug-ins for physical agents and measurements. The concept of a “class hierarchy” is a well-known object-oriented programming concept, based on the well-known object-oriented programming concept of a “class”.

Referring now to FIG. 4, class hierarchy 70 of GUI integration framework 18 includes, for example, GUI measurement objects 72, GUI test objects 74 and a GUI test manager object 76. Class hierarchy 70 is arranged with GUI test manager object 76 above GUI test objects 74, and GUI test objects 74 above GUI measurement objects 72.

GUI measurement objects 72 are for configuring and controlling, from GUI 16, measurements running on a physical agent. GUI measurement objects 72 might also, for example, provide a results view of a measurement. GUI measurement objects 72 would, for example, typically provide for a consistent look and feel for all measurements regardless of the underlying agent type, via the use of common APIs to configure the measurements and display their results.

GUI test objects 74 are for adding and deleting measurements to/from tests. More specifically, GUI test objects 74 allow an end user to add a new measurement to a test, and to later delete the measurement from the test. GUI test objects 74 might, for example, provide a summary view the correlates results from running measurements. GUI test objects 74 would, for example, typically provide for a consistent look and feel for all measurements regardless of the underlying agent type, via the use of common APIs to configure the measurements and display their results. GUI measurement objects 72 are derivable to create new measurements. Similarly, GUI test objects 74 are derivable to create new tests. The concept of an object being “derivable” is a well-known object-oriented programming concept.

GUI test manager object 76 is for creating and deleting tests on GUI 16. For example, GUI test manager object 76 allows an end user to add a new test, and delete the test when it is completed. GUI test manager object 76 might also, for example, provide a test summary view for the end user via GUI 16 that correlates results from running tests.

FIG. 5 is a diagram illustrating an object-oriented class hierarchy 80 for server integration framework 28 of distributed testing system 10, according to an embodiment of the present invention. More specifically, class hierarchy 80 interfaces server 14 with server plug-ins.

Referring now to FIG. 5, class hierarchy 80 includes, for example, server measurement objects 82, server test objects 84 and server test manager 86. Class hierarchy 80 is arranged with server test manager object 86 above server test objects 84, and server test objects 84 above server measurement objects 82.

Server measurement objects 82 are for configuring and controlling measurements. Server measurement objects 82 are derivable to create new measurements. Server measurement objects 82 might also, for example, provide a results view of a measurement. Server measurement objects 82 would, for example, typically provide for a consistent look and feel for all measurements regardless of the underlying agent type, via the use of common APIs to configure the measurements and display their results.

Server test objects 84 are for adding and deleting measurements to/from tests. Server test objects 84 are derivable to create new tests. Server test objects 84 would, for example, typically provide a common data representation for correlated summary data for each running measurement. Server test objects 84 would, for example, typically provide for consistent access to physical agent configurations and measurements regardless of the underlying agent type.

Server test manager object 86 is for creating and deleting tests on server 14. Server test manager object 86 would, for example, typically provide a common data representation for correlated summary data for each running test to support GUI 16.

As can be seen from FIGS. 4 and 5, class hierarchies 70 and 80 logically represent a test and measurement paradigm in GUI 16 and server 14, respectively. Common expressions would typically be expressed in class hierarchies 70 and 80. Such common expressions might include, for example, operations such as run, stop, configure, get results, display results, etc. However, the present invention is not limited to these expressions. Class hierarchy 70 and class hierarchy 80 are only examples of class hierarchies, and the present invention is not limited to these specific examples. Many variations are possible.

Agent integration framework 36 can be understood, for example, by referring to patent application titled “EXTENSIBLE NETWORK AGENT METHOD, SYSTEM, AND ARCHITECTURE”, inventors Merlin A. Rhoda, et al., Attorney Docket PD No. 10030966-1, filed Oct. 31, 2003, which is incorporated herein by reference.

According to above embodiments of the present invention, a distributed testing system includes (a) a logical agent; (b) a server communicating with the logical agent; (c) a graphical user interface (GUI) communicating with the server; and (d) a framework (for example, the combination of GUI integration framework 18, server integration framework 28 and agent integration framework 36). The framework interfaces physical agents to the logical agent, the server and the GUI via plug-ins. The framework also interfaces a plurality of measurements to the server and the GUI via plug-ins. The interfaced physical agents perform the interfaced heterogeneous measurement for a test in accordance with control by an end user via the GUI.

The present invention relates to a distributed testing system. Generally, “distributed” indicates that processing power is distributed among different devices which might, for example, be in different locations. For example, in a distributed testing system, processing power might be distributed among a server and physical agents. The physical agents might be in very different, remote locations connected to different points in a network under test. As an example, a server might be located in Denver, Colo., and physical agents connected to the server might be located in New York, N.Y., and in Chicago, Ill. As an additional example, the server and physical agents might be located in different buildings, or simply in different rooms of the same building. The concept of a “distributed” system would be well-understood by a person of ordinary skill in the art.

The present invention relates to “heterogeneous” measurements. Generally, “heterogeneous” indicates that the measurements are not the same and/or are performed by different physical agents. The concept of a “heterogeneous” measurement is well-known.

Therefore, the present invention provides a distributed testing system which allows an end user to perform a test of a network via a single GUI, and allows a server to correlate and aggregate measurements for the test and display the results to the end user via the GUI. The distributed testing system is extensible to add new measurements and new physical agents without technical intervention, via the use of integration frameworks and plug-ins.

Above embodiments of the present invention allow arbitrary measurement functionality to be added to a distributed testing system in such a way as to provide for extensibility without impacting the existing system. Accordingly, system engineers/operators are free from integrating new measurements, interfaces or agents. Moreover, new products (such as new measurements and/or physical agents) can ship independently of the distributed testing system, and be added later. Measurements written for new technologies can be directly leveraged into the distributed testing system.

In accordance with the above, the present invention allows an end user to create and run a test of a network from a single GUI, where the test is a collection of measurements correlated together. For example, via the GUI, the end user can create measurements for a test and indicate which physical agents will perform the measurements. For example, the end user can create a test including five different measurements run by five different physical agents, respectively, in accordance with control and configuration by the end user via the GUI. Results from the test can then be displayed for the end user on the GUI.

Moreover, above embodiments of the present invention support runtime loading. “Runtime loading” indicates that software code can be added to the distributed testing system after the system has been built. System engineers/operators do not have to manually add new products into the existing code base.

The present invention relates to testing of a network. The present invention is not limited to any particular type of network or any particular type of network protocols or technology. For example, a network might be based on, or be a combination of, wired, wireless, optical, circuit-switched, packet and/or voice-over-Internet Protocol (VOIP) technologies. A network might be, for example, a public, private or combination public/private network. A network might be or include, for example, the Internet.

The present invention relates to tests and measurements. The present invention is not limited to any particular tests or any particular measurements.

Although a few preferred embodiments of the present invention have been shown and described, it would be appreciated by those skilled in the art that changes may be made in these embodiments without departing from the principles and spirit of the invention, the scope of which is defined in the claims and their equivalents.

1. An apparatus comprising:
a distributed testing system comprising a logical agent, a server communicating with the logical agent and a graphical user interface (GUI) communicating with the server, the distributed testing system being extensible to, without technical intervention, interface with physical agents and heterogeneous measurements so that the interfaced physical agents perform the interfaced heterogeneous measurements for a test in accordance with control by an end user via the GUI.

2. An apparatus as in claim 1, further comprising:
a framework interfacing the physical agents and the heterogeneous measurements to the distributed testing system.

3. An apparatus as in claim 1, further comprising:
means for interfacing the physical agents and the heterogeneous measurements to the distributed testing system.

4. An apparatus as in claim 2, wherein the framework comprises:
a GUI integration framework interfacing the GUI with GUI plug-ins for the physical agents, and interfacing the GUI with GUI plug-ins for the heterogeneous measurements;
a server integration framework interfacing the server with server plug-ins for the physical agents, and interfacing the server with server plug-ins for the heterogeneous measurements; and
an agent integration framework interfacing the logical agent with agent plug-ins for the physical agents.

5. An apparatus as in claim 4, wherein
the GUI integration framework comprises an object-oriented class hierarchy for interfacing the GUI with the GUI plug-ins; and
the server integration framework comprises an object-oriented class hierarchy for interfacing the server with the server plug-ins.

6. An apparatus as in claim 5, wherein the class hierarchy of the GUI integration framework comprises:
GUI measurement objects for configuring and controlling measurements, the GUI measurement objects being derivable to create new measurements;
GUI test objects for adding and deleting measurements to/from tests, the GUI test objects being derivable to create new tests; and
a GUI test manager object for creating and deleting tests on the GUI,
the class hierarchy thereby being arranged with the GUI test manager object above the GUI test objects, and the GUI test objects being above the GUI measurement objects.

7. An apparatus as in claim 5, wherein the class hierarchy of the server integration framework comprises:
server measurement objects for configuring and controlling measurements, the server measurement objects being derivable to create new measurements;
server test objects for adding and deleting measurements to/from tests, the server test objects being derivable to create new tests; and
a server test manager object for creating and deleting tests on the server,
the class hierarchy thereby being arranged with the server test manager object above the server test objects, and the server test objects being above the server measurement objects.

8. An apparatus as in claim 5, wherein
the class hierarchy of the GUI integration framework comprises
GUI measurement objects for configuring and controlling measurements, the GUI measurement objects being derivable to create new measurements,
GUI test objects for adding and deleting measurements to/from tests, the GUI test objects being derivable to create new tests, and
a GUI test manager object for creating and deleting tests on the GUI,
the class hierarchy thereby being arranged with the GUI test manager object above the GUI test objects, and the GUI test objects being above the GUI measurement objects, and
the class hierarchy of the server integration framework comprises
server measurement objects for configuring and controlling measurements, the server measurement objects being derivable to create new measurements,
server test objects for adding and deleting measurements to/from tests, the server test objects being derivable to create new tests, and
a server test manager object for creating and deleting tests on the server,
the class hierarchy thereby being arranged with the server test manager object above the server test objects, and the server test objects being above the server measurement objects.

9. An apparatus comprising:
a logical agent;
a server communicating with the logical agent;
a graphical user interface (GUI) communicating with the server; and
a framework interfacing, without technical intervention, physical agents to the logical agent, the server and the GUI via plug-ins, and interfacing, without technical intervention, a plurality of measurements to the server and the GUI via plug-ins, the interfaced physical agents thereby performing the interfaced heterogeneous measurement for a test in accordance with control by an end user via the GUI.

10. An apparatus as in claim 9, wherein the framework comprises:
a GUI integration framework interfacing the GUI with GUI plug-ins for the physical agents, and interfacing the GUI with GUI plug-ins for the heterogeneous measurements;
a server integration framework interfacing the server with server plug-ins for the physical agents, and interfacing the server with server plug-ins for the heterogeneous measurements; and
an agent integration framework interfacing the logical agent with agent plug-ins for the physical agents.

11. An apparatus comprising:
a logical agent;
a server communicating with the logical agent;
a graphical user interface (GUI) communicating with the server;
a GUI integration framework interfacing the GUI with GUI plug-ins for physical agents, and interfacing the GUI with GUI plug-ins for heterogeneous measurements;
a server integration framework interfacing the server with server plug-ins for the physical agents, and interfacing the server with server plug-ins for the heterogeneous measurements; and
an agent integration framework interfacing the logical agent with agent plug-ins for the physical agents, the physical agents thereby performing the heterogeneous measurements for a test in accordance with control by an end user via the GUI.

12. An apparatus as in claim 11, wherein
the GUI integration framework comprises an object-oriented class hierarchy for interfacing the GUI with the GUI plug-ins; and
the server integration framework comprises an object-oriented class hierarchy for interfacing the server with the server plug-ins.

13. An apparatus as in claim 12, wherein the class hierarchy of the GUI integration framework comprises:
GUI measurement objects for configuring and controlling measurements, the GUI measurement objects being derivable to create new measurements;
GUI test objects for adding and deleting measurements from tests, the GUI test objects being derivable to create new tests; and
a GUI test manager object for creating and deleting tests on the GUI,
the class hierarchy thereby being arranged with the GUI test manager object above the GUI test objects, and the GUI test objects being above the GUI measurement objects.

14. An apparatus as in claim 12, wherein the class hierarchy of the server integration framework comprises:
server measurement objects for configuring and controlling measurements, the server measurement objects being derivable to create new measurements;
server test objects for adding and deleting measurements from tests, the server test objects being derivable to create new tests; and
a server test manager object for creating and deleting tests on the server,
the class hierarchy thereby being arranged with the server test manager object above the server test objects, and the server test objects being above the server measurement objects.

15. An apparatus as in claim 12, wherein
the class hierarchy of the GUI integration framework comprises
GUI measurement objects for configuring and controlling measurements, the GUI measurement objects being derivable to create new measurements,
GUI test objects for adding and deleting measurements from tests, the GUI test objects being derivable to create new tests, and
a GUI test manager object for creating and deleting tests on the GUI,
the class hierarchy thereby being arranged with the GUI test manager object above the GUI test objects, and the GUI test objects being above the GUI measurement objects, and
the class hierarchy of the server integration framework comprises
server measurement objects for configuring and controlling measurements, the server measurement objects being derivable to create new measurements,
server test objects for adding and deleting measurements from tests, the server test objects being derivable to create new tests, and
a server test manager object for creating and deleting tests on the server,
the class hierarchy thereby being arranged with the server test manager object above the server test objects, and the server test objects being above the server measurement objects.

16. An apparatus comprising:
a logical agent;
a server communicating with the logical agent;
a graphical user interface (GUI) communicating with the server;
means for interfacing the GUI with GUI plug-ins for physical agents, and for interfacing the GUI with GUI plug-ins for heterogeneous measurements;
means for interfacing the server with server plug-ins for the physical agents, and for interfacing the server with server plug-ins for the heterogeneous measurements; and
means for interfacing the logical agent with agent plug-ins for the physical agents, the physical agents thereby performing the heterogeneous measurements for a test in accordance with control by an end user via the GUI.
